(19) United States
(12) Patent Application Publication
(10) Pub. No.: US 2002/0016869 A1
(43) Pub. Date: Feb. 7, 2002

(54) Data path engine

(76) Inventors: Guillaume Comeau, Quebec (CA); Andreas Paramonoff, La Jolla, CA (US)

Correspondence Address: Zucotto Wireless Inc., c/o Mark Wardas, 4225 Executive Square, Ste. 400, La Jolla, CA, 92037, US

(21) Appl. No.: 09/886,665

(22) Filed: Jun. 21, 2001

Related U.S. Application Data
(63) Continuation-in-part of application No. 09/871,481, filed on May 31, 2001.
(60) Provisional application No. 60/220,047, filed on Jul. 21, 2000.
(60) Provisional application No. 60/239,320, filed on Oct. 10, 2000.
(60) Provisional application No. 60/267,555, filed on Feb. 9, 2001.
(60) Provisional application No. 60/217,811, filed on Jul. 12, 2000.
(60) Provisional application No. 60/228,540, filed on Aug. 28, 2000.
(60) Provisional application No. 60/213,408, filed on Jun. 22, 2000.
(60) Provisional application No. 60/257,553, filed on Dec. 22, 2000.
(60) Provisional application No. 60/282,715, filed on Apr. 10, 2001.

(51) Int. Cl. G06F 9/46; G06F 17/00

(52) U.S. Cl. 709/324; 709/108; 707/100

(57) ABSTRACT

A method and apparatus are provided for performing operations on data transferred between a peripheral directly into a data structure stored in a memory. The data structure may comprise a Java or Java-like data structure.

### RELATED APPLICATIONS

This Application claims priority from Provisional Application Ser. No. 60/220,047, filed on Jul. 21, 2000; Provisional Application Ser. No. 60/239,320, filed on Oct. 10, 2000; Provisional Application Ser. No. 60/267,555, filed on Feb. 9, 2001; Provisional Application Ser. No. 60/217,811, filed on Jul. 12, 2000; Provisional Application Ser. No. 60/228,540, filed on Aug. 28, 2000; Provisional Application Ser. No. 60/213,408, filed on Jun. 22, 2000; Provisional Application Ser. No. 60/257,553, filed on Dec. 22, 2000; Provisional Application Ser. No. 60/282,715, filed on Apr. 10, 2001; and U.S. patent application Ser. No. 09/849,648, filed on May 4, 2001; and U.S. patent application Ser. No. 09/871,481, filed on May 31, 2001, all of which are commonly assigned.

### FIELD OF THE INVENTION

The description provided herein relates to efficient data and information transfers between a peripheral and a memory of a device in general and to efficient data and information transfers between wireless devices running Java or Java-like languages in particular.

### BACKGROUND

As access to global networks grows, it is increasingly possible for carriers to offer compelling services to their subscribers. In the case of wireless carriers, the carriers have the ability to reach customers and provide “anytime, anywhere” services. However, a service based revenue model is difficult to implement in portable devices. It may be preferable for carriers to outsource the design of these services. It may behoove carriers, therefore, to choose a design, which supports an environment that behaves consistently from one device to another as well as to provide protection from malicious attack such as software viruses or fraud.

Various implementations of a Java byte-compiled object oriented programming language are available from Sun Microsystems, Inc. 901 San Antonio Road Palo Alto, Calif. 94303 as well as others are well known in the art. Although these implementations may resolve portability and security issues in portable devices, they can impose limitations on overall system performance. First, a semi-compiled/interpreted language, like Java, and an associated virtual machine or interpreter running on a conventional portable power-constrained device can consume roughly ten times more power than a native application. Second, due to Java language and run time environment feature redundancy, Java ported onto an existing operating system requires a large memory footprint. Third, the development of a wireless protocol stack for such a system is very difficult given the real-time constraints, which are inherent in the operation of existing processors. Fourth, execution speed is relatively slow. Fifth, data and programs downloaded to a portable device capable of running Java applications may require significant processing and data handling overhead when interfaced to a processor and/or a main operating system.

In an attempt to solve Java application execution speed limitations, a number of approaches to accelerate Java on embedded devices have been developed, including: software emulation, just-in-time-compiling (JIT), hardware accelerators on existing processor cores, and Java processor cores. Software emulation is the slowest and most power consumptive implementation. JIT provides increased speed by software translation between Java byte-codes and native code, but requires significant amounts of memory to store a cross compiler program and significant processing resources, and also exhibits a time lag between when the program is downloaded and when it is ready to executed. Most hardware accelerators on existing processor cores are more or less equivalent to JIT, with similar performance, but increased chip gate count. One of the biggest challenges with hardware accelerators is in the software integration of a required Java virtual machine with a coexisting operating system running on the processor.

Software emulation, JIT, and hardware accelerators cannot provide an optimal level of design integration for embedded devices because they must respect traditional software architecture boundaries. Although it is possible to obtain an advantage over hardware accelerators with Java processor cores, previous solutions are non optimal solutions directed to general-purpose applications, or have been targeted to industrial or control applications which are sub-optimal for wireless or consumer devices.

Referring to FIG. 1, there is seen one prior art system architecture on which a Java virtual machine (VM) is implemented. One factor that plays a critical role in overall system performance and power consumption of previous Java implementations in traditional systems is the boundary between a processor core 190, peripherals 197, and software representations 11 of the peripherals 197. The most common system architecture follows horizontal layers, which provide abstractions to peripherals. In terms of processing resources, the natural split in these layers results in mediocre efficiency. Known Java hardware accelerator solutions that utilize a VM 10, fail to optimize the path between peripherals 197 and their software representation 11.

Referring to FIG. 2 and other preceding Figures as needed, there is seen control and data paths of a prior art system. System 199 communicates across a wireless network in which a frame of data from an external network is received by peripherals 197. Until the frame is wrapped into a Java object 191, the system operates generally in the following steps:

1. A packet of data from an off-chip peripheral 197 (for example a baseband circuit), is received and the packet is stored in a receive FIFO 198 of a processor 190 operating under control of a processor core 196.

2. The receive FIFO 198 triggers an interrupt service routine, which copies the packet to a serial receive buffer 192 of a device driver associated with the peripheral. The packet is now in the realm of an operating system, which may signal a Java application to service the receive buffer 192. Since the system 199 follows the usual hardware, operating system, virtual machine paradigm, it is necessary to buffer the packet under the control of an operating system device driver to guarantee latency and prevent FIFO 198 overflow.

3. A Java scheduler is activated to change execution to the Java listener thread associated with the peripheral device.

4. A listener thread, that is active, issues native function calls (JNI) to get data out of the receive buffer 192, to allocate a block of memory of corresponding size, and to copy the packet into a Java object 191.

In system 199, it is apparent why targeting of applications is important. Even if the processor 190 is very fast, since the path followed by the packet is very convoluted, it is not transferred efficiently. While the goal is to get the packet from the FIFO 198 into a Java object 191 as efficiently as possible, the system copies bytes individually to memory at least twice, toggles bus lines continuously throughout the process, and causes excessive switching inside the processor 190 and memories 195 and 194 and thus excessive power consumption.

Thus, there exists a need for a new solution that provides efficient processing of data transferred by wireless means. Although various approaches have been developed for handling transmission of data over the wireless medium, they are not optimized for efficient processing of data by a software stack that consists of multiple layers, let alone, by multiple layers of multiple software stacks. There are known to exist in the software arts various software constructs. For example, in the UNIX arts there are Mbuf class constructs, which are known as malloc'ed, multi-chunk-supporting, memory-buffers. The memory-buffers may be extended by either appending data to the construct (which may reallocate the last chunk of data to fit the new characters) and/or by adding more pre-allocated chunks of data to the construct (which can be either appended or prepended to the list of buffer chunks). When using software constructs to pass information between layers of a software stack, it is possible that unbounded operations or corruption of information may occur. It is desirable that unbounded operations be avoided when processing data with software stacks, as well as to process and pass the data between software layers efficiently and without corruption.

What is needed, therefore, is a device and methodology, which can improve upon the deficiencies of the prior art.

### SUMMARY OF THE INVENTION

In one embodiment, an apparatus for utilizing information, comprises: a memory, the memory comprising at least one data structure; and a plurality of layers, each layer comprising at least one thread, each thread utilizing each data structure from the same portion of the memory. The apparatus may comprise an application layer and a hardware layer, wherein the application layer comprises one of the plurality of layers, wherein the hardware layer comprises one of the plurality of layers, wherein the application layer and hardware layer utilize each data structure from the same portion of memory. At least one of the plurality of layers may comprise a realtime thread. Each data structure may comprise a block object, wherein at least a portion of each block object is comprised of a contiguous portion of the memory. The contiguous portion of the memory may be defined a byte array. The at least one data structure may comprise a block object. The apparatus may comprise a Java or Java-like virtual machine, wherein each thread comprises a Java or Java-like thread, wherein the Java or Java-like thread utilizes the same portion of memory independent of Java or Java-like monitors. The apparatus may comprise interrupt means for disabling interrupts; and a Java or Java-like virtual machine capable of executing each thread, wherein each thread utilizes the same portion of memory after the interrupts are disabled by the interrupt means. All interrupts are disabled before each thread utilizes the same portion of memory. The threads may disable the interrupts via the interrupt means. The information may be received by the apparatus as streamed information, wherein each data structure is preallocated to the memory prior reception of the information. The apparatus may comprise a freelist data structure, wherein each block object is preallocated to the freelist data structure by the apparatus prior to utilization of the information. The apparatus may comprise a protocol stack, the protocol stack residing in the memory, wherein the protocol stack preallocates each block to the freelist data structure. The apparatus further may comprise a virtual machine, the virtual machine utilizing a garbage collection mechanism, the virtual machine running each thread, each thread utilizing the same portion of the memory independent of the garbage collection mechanism. The garbage collection mechanism may comprise a thread, wherein the threads comprise Java-like threads, wherein the threads each comprise a priority, wherein the priority of the Java-like threads is higher than the priority of the garbage collection thread. Each data structure may comprise a block object, and further comprising a freelist data structure and at least one queue data structure, each block object comprising a respective handle, wherein at any given time the respective handle belongs to the freelist data structure or a queue data structure. The apparatus may comprise at least one queue data structure; and at least one frame data structure, each frame data structure comprising an instance of one or more block objects, each block object comprising a respective handle, each queue data structure capable of holding an instance of at least one frame data structure, and each thread using the queue data structure to pass a block handle to another thread. The apparatus may comprise a virtual machine, the virtual machine running each thread; at least one queueendpoint, each queueendpoint comprising at least one of the threads; and at least one queue, each queue comprising ends, each end bounded by a queueendpoint, each queue for holding each of data structures in a data path for use by each queuendpoint, wherein each queue notifies a respective queueendpoint when the queue needs to be serviced by the queueendpoint, wherein a queueendpoint passes instances of each data structure from one queue to another queue by a respective handle belonging to the data structure. A queue may notifies a respective queueendpoint upon the occurrence of a queue empty event, queue not empty event, queue congested event, or queue not congested event. The apparatus may comprise a queue status data structure shared by a queue and a respective queueendpoint, wherein the queue sets a flag in the data status structure to notify the respective queueendpoint when the queue needs to be serviced.

In one embodiment, an apparatus for utilizing a stream of information in a data path, may comprise: a memory, the memory comprising at least one data structure, each data structure comprising a pointer; a plurality of layers, the data path comprising the plurality of layers, the stream of information comprising the at least one data structure, each layer utilizing each data structure via its pointer. Each layer may comprise at least one thread, each thread utilizing each data structure from the same portion of the memory. The apparatus may comprise an interrupt disabling mechanism; and at least one queue, each queue disposed in the data path between a first layer and a second layer, the first layer comprising a producer thread, the second layer comprising a consumer thread, the producer thread for enqueuing each data structure onto a queue, the consumer thread for dequeing each data structure from the queue, wherein prior to dequeing and enqueing each data structure interrupts are disabled. The apparatus may comprise a virtual machine, the virtual machine comprising a garbage collection mechanism, the virtual machine running each thread independent of the garbage collection mechanism.

In one embodiment, a system for utilizing data structure with a plurality of threads, may comprise; an interrupt mechanism for enabling and disabling interrupts; a memory, the memory comprising at least one data structure; and a plurality of threads, the plurality of threads utilizing the data structures after disabling interrupts with the interrupt mechanism. The plurality of threads may utilize each of the data structures from the same portion of memory.

In one embodiment, a system for accessing streaming information with a plurality of threads, may comprise: a memory; and interrupt means for enabling and disabling interrupts; wherein the plurality of threads access the streaming information from the memory by disabling the interrupts via the interrupt means. The system may comprise a memory, wherein the plurality of threads access the streaming information from the same portion of the memory.

In one embodiment, a method for accessing information in a memory with a plurality of threads, may comprise the steps of: transferring information from one thread to another thread via handles to the information; and disabling interrupts via the threads before performing the step of transferring the information. The method may comprise a step of accessing the information with the plurality of threads from the same portion of the memory.

These as well as other aspects of the invention discussed above may be present in embodiments of the invention in other combinations, separately, or in combination with other aspects and will be better understood with reference to the following drawings, description, and appended claims.

### BRIEF DESCRIPTION OF THE DRAWINGS

FIG. 1 illustrates one prior art system architecture on which a virtual machine (VM) is implemented;

FIG. 2 illustrates control and data paths of a prior art system;

FIG. 3a illustrates a top-level block diagram architecture of an embodiment described herein;

FIG. 3b illustrates an embodiment in which byte-codes are fetched from memory by an MMU, with control and address information passed from a Prefetch Unit;

FIG. 3c illustrates an embodiment wherein trapped instruction may be transferred to software control;

FIG. 4 illustrates a representation of a software protocol stack;

FIG. 5 illustrates an embodiment of a Data Path Engine;

FIGS. 6a-e illustrate embodiment of various data structures utilized by the Data Path Engine;

FIGS. 7a-b illustrate embodiments of two subsystems of the Data Path Engine;

FIG. 8 illustrates multiple queues interacting with queueendpoints.

FIG. 9 illustrates an interaction between FreeList, Frame, Queue, and Block data structures;

FIG. 10 illustrates an embodiment of a hardware interface to the Data Path Engine;

FIG. 11 illustrates an embodiment as described herein;

FIG. 12 illustrates representation of a transfer of data into a software data structure; and

FIG. 13 illustrates an embodiment as described herein.

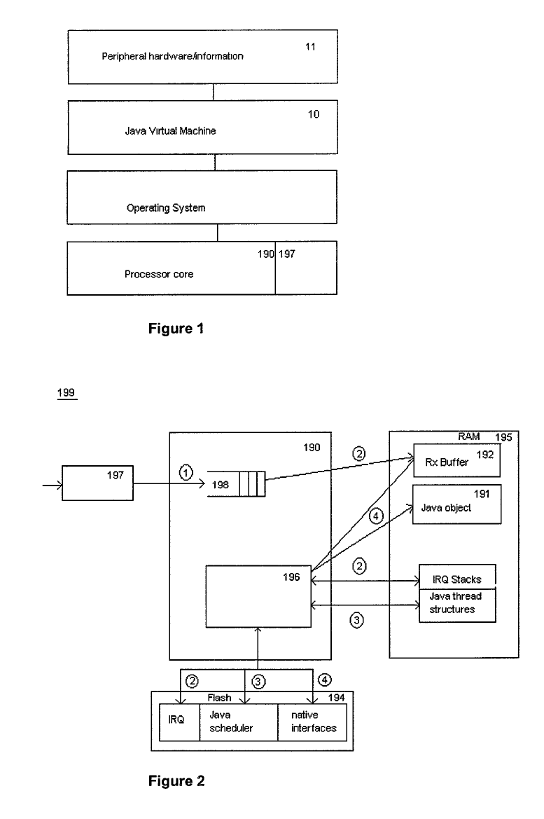

### DESCRIPTION OF THE INVENTION

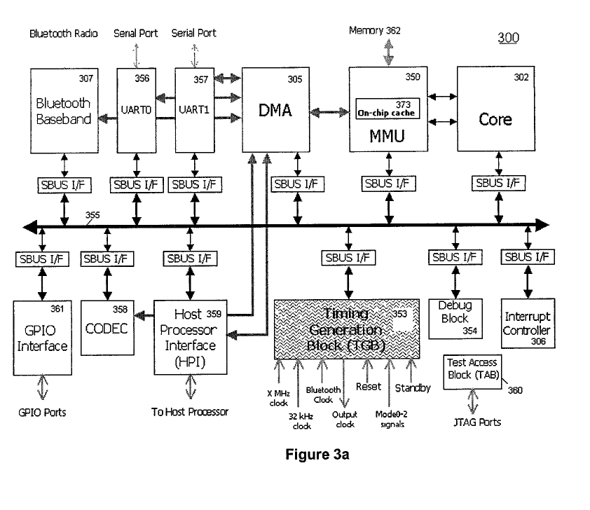

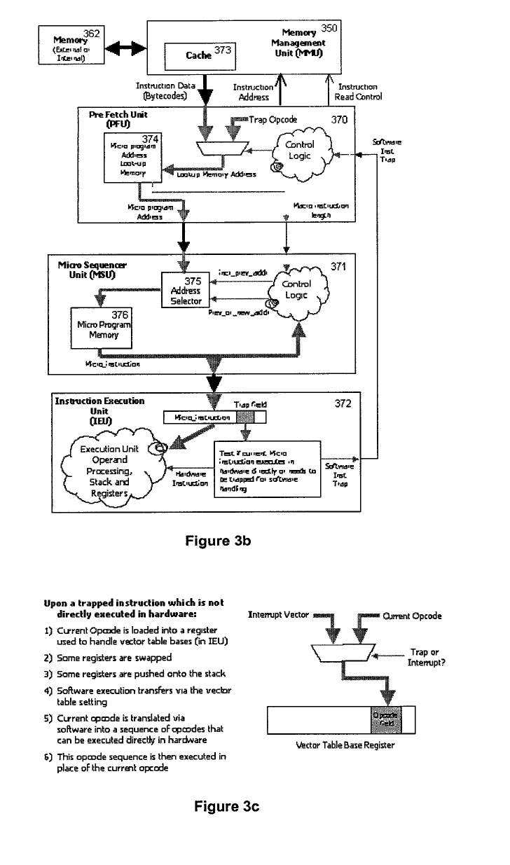

Referring to FIG. 3 and other Figures as needed, there is seen a top-level block diagram architecture of an embodiment described herein. In one embodiment, a circuit 300 may comprise a processor core 302 that may be used to perform operations on data that is directly and dynamically transferred between the circuit 300 and peripherals or devices on or off the circuit 300. In one embodiment, the circuit 300 may comprise an instruction execution means for executing instructions, for example, application program instructions, application program threads, hardware threads of execution, and processor read or write instructions. In one embodiment, the data may comprise instructions of a semi-compiled or interpreted programming language utilizing byte-codes, binary executable data, data transfer protocol packets such as TCP/IP, Bluetooth packets, or streaming data received by a peripheral or device and transferred from the peripheral or device directly to a memory location. In one embodiment, after a transfer of data from the peripheral or device to the memory location occurs, operations may be performed on the data without the need for further transfers of the data to, or from, the memory.

In one embodiment, the circuit 300 may comprise a Memory Management Unit (MMU) 350, a Direct Memory Access (DMA) controller 305, an Interrupt Controller 306, a Timing Generation Block (TGB) 353, a memory 362, and a Debug Controller 354. The Debug Controller 354 may include functionality that allows the processor core 302 to upload micro-program instructions to memory at boot-up. The Debug Controller 354 may also allow low level access to the processor core 302 for program debug purposes. The MMU 350 may act as an arbiter to control accesses to an Instruction and Data Cache of memory 373, to external memories, and to DMA controller 305. The MMU 350 may implement the Instruction and Data Cache memory 362 access policy. The MMU 350 may also arbitrate DMA 305 accesses between the processor core 302 and peripherals or devices on or off the circuit 300. The DMA 305 may connect to a system bus (SBUS) 355 and may include channels for communicating with various peripherals or devices, including: to a wireless baseband circuit 307, to UART1 356, to UART2 357, to Codec 358, to Host Processor Interface (HPI) 359, and to MMU 350.

In one embodiment, the SBUS 355 allows one master to poll several slaves for read and write accesses, i.e., one slave per bus access cycle. The processor core 302 may be the SBUS master. In one embodiment, only the SBUS master may request a read or write access to the SBUS 302 at any time. In one embodiment, peripherals or devices may be slaves and are memory mapped, i.e. a read/write access to a peripheral or device is similar to a memory access. If a slave has new data for the master to read, or needs new data to consume, it may send an interrupt to the master, which reacts by polling all slaves to discover the interrupting slave and the reason for the interruption. The UARTs 356/357 may open a bi-directional serial communication channel between the processor core 302 and external peripherals. The Codec 358 may provide standard voice coding/decoding for the baseband circuit 307 or other units requiring voice coding/decoding. In one embodiment, the circuit 300 may comprise other functionalities, including a Test Access Block (TAB) 360 comprising a JTAG interface and a general purpose input/output interface (GPIO) 361.

In one embodiment, circuit 300 may also comprise a Debug Bus (DBUS) (not shown). The DBUS may connect peripherals through the GPIO 361 to external debugging devices. The DBUS bus may allow monitoring of the state of internal registers and on-chip memories at run-time. It may also allow direct writing to internal registers and on-chip memories at run time.

In one embodiment, the processor core 302 may be implemented on a circuit 300 comprising an ASIC. The processor core 302 may comprise a complex instruction set (CISC) machine, with a variable instruction cycle and optimizations for executing software byte-codes of an semi-compiled/interpreted language directly without high level translation or interpretation. The software byte-code instructions may comprise byte-codes supported by the VM functionality of a software support layer (not shown). An embodiment of a software support layer is described in commonly assigned U.S. Ppatent application Ser. No. 09/767,038, filed Jan. 22, 2001. In one embodiment, the byte-codes comprise Java or Java-like byte-codes. In one embodiment, in addition to a native instruction set, the processor core 302 may execute the byte-codes. The circuit 300 may employ two levels of programmability/executability; as macro-instructions and as micro-instructions. In one embodiment, the processor core 302 may execute macro-instructions under control of the software support layer, or each macro-instruction may be translated into a sequence of micro-instructions that may be executed directly by the processor core 302. In one embodiment, each micro-instruction may be executed in one-clock cycle.

In one embodiment, the software layer may operate within an operating system/environment, for example, a commercial operating system such as the Windows(® OS or Windows® CE, both available from Microsoft Corp., Redmond, Wash. In one embodiment, the software layer may operate within a real time operating system (RTOS) environment such as pSOS and VxWorks available from Wind River Systems, Inc., Alameda, Calif. In one embodiment, the software layer may provide its own operating system functionality. In one embodiment, the software support layer may implement or operate within or alongside a Java or Java-like virtual machine (VM), portions of which may be implemented in hardware. In one embodiment, portions of the VM not included as the software support layer may be included as hardware. In one embodiment, the VM may comprise a Java or Java-like VM embodied to utilize Java 2 Platform, Enterprise Edition (J2EE™), Java 2 Platform, Standard Edition (J2SE™), and/or Java 2 Platform, Micro Edition (J2ME™) programming platforms available from Sun Microsystems. Both J2SE and J2ME provide a standard set of Java programming features, with J2ME providing a subset of the features of J2SE for programming platforms that have limited memory and power resources (i.e., including but not limited to cell phones, PDAs, etc.), while J2EE is targeted at enterprise class server platforms.

Referring to FIG. 3b and other Figures as needed, there is seen an embodiment in which byte-codes are fetched from memory 362 by a MMU 350, with control and address information passed from a Prefetch Unit 370. In one embodiment, byte-codes may be used as addresses into a look-up memory 374 of a Pre Fetch Unit (PFU) 370, which may be used to store an address of a corresponding sequence of micro-instructions that are required to implement the byte-codes. The address of the start of a micro-instruction sequence may be read from look-up memory 374 as indicated by the Micro Program Address. The number of micro-instructions (Macro instruction length) required may also be output from the look-up memory 374.

Control logic in a Micro Sequencer Unit (MSU) 371 may be used to determine whether the current byte-code should continue to be executed, and whether the current Micro Program address may be used or incremented, or whether a new byte-code should be executed. An Address Selector block 375 in the MSU 371 may handle the increment or selection of the Micro Program Address from the PFU 370. The address output from the Address Selector Block 375 may be used to read a micro-instruction word from the Micro Program Memory 376.

The micro-instruction word may be passed to the Instruction Execution Unit (IEU) 372. The IEU 372 may check trap bits of the micro-instruction word to determine if it can be executed directly by hardware, or if it needs to be handled by software. If the micro-instruction can be executed by hardware directly, it may be passed to the IEU, register, ALU, and stack for execution. If the instruction triggers a software trap exception, a Software Inst Trap signal may set to true.

The Software Inst Trap signal may be fed back to the Pre Fetch Unit 370, where it may be processed and used to multiplex in a trap op-code. The trap op-code may be used to address a Micro Program address, which in turn may be used to address the Micro Program Memory 376 to read a set of micro-instructions that are used to handle the trapped instruction and to transfer control to the associated software support layer. FIG. 3c illustrates how trapped instruction may be transferred to software control.

In one embodiment, byte-codes may comprise a conditionally trapped instruction. For example, depending on the state of the processor core 302, the conditionally trapped instruction may be executed directly in hardware or may trapped and handled in software.

The present invention identifies that benefits derive when information is passed between wireless devices by an software protocol stack written partly or entirely in a Java or Java-like language. Although an approach could be used to provide a solution implemented partly in native code and partly in a Java or Java-like language, with such an approach it would be very hard to assess overall system effects of design decisions, since only half of the system (native or Java) would be visible. For example, in a Java system using a software virtual machine (VM), use of previous Unix Mbuf constructs would require semaphores and native threads, which would incur extra overhead and complexity. Although in a Unix system it might be possible to process the MBuf constructs above the Java layer, a system designer would have to first figure out a methodology to get the data to the Java level, how to keep Java garbage collection from interfering, and how to guarantee data integrity and contentions. The present invention interfaces with an upper software protocol stack written entirely in Java or Java-like semi-interpreted languages so as to avoid having to cross over native code boundaries multiple times. By using an all Java or Java-like protocol stack, however, various system issues need to be addressed, including, synchronization, garbage collection, interrupts as well as aforementioned instruction trapping.

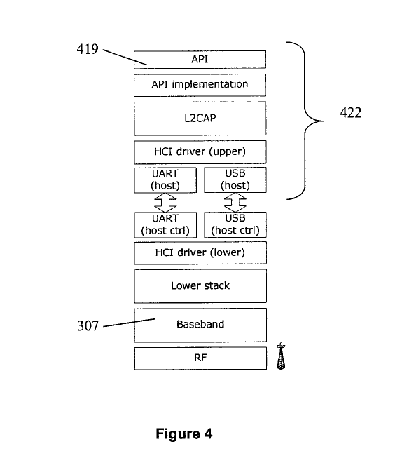

Referring now to FIG. 4, there is seen a representation of a software protocol stack. One embodiment of an upper software protocol stack 422 written in Java or a Java-like language is described in commonly assigned U.S. patent application Ser. No. 09/849,648, filed on May 4, 2001. In one embodiment, the protocol stack 422 may comprise software data structures compatible with the functionality provided by Java or Java-like programming languages. The protocol stack 422 may utilize an API 419 that provides a communication path to application programs (not shown) at the top of the stack, and a lower 488 interface to a baseband circuit 307. The protocol stack also interfaces to a software support layer, the functionality of which is described in previously referenced U.S. patent application Ser. No. 09/767,038, filed on Jan. 22, 2001, wherein is provided a Virtual machine (VM) with no operating system (OS) overhead and wherein Java classes can directly access hardware resources.

The protocol stack 422 may comprise various layers/modules/profiles (hereafter layers) with which received or transmitted information may be processed. In one embodiment, the protocol stack 422 may operate on information communicated over a wireless medium, but it is understood that information could also be communicated to the protocol stack over a wired medium. In other embodiments it is understood that the invention disclosed herein may find applicability to layers embodied as part of other than a wireless protocol stack, for example other types of applications that pass information between layers of software, for example, a TCP/IP stack.

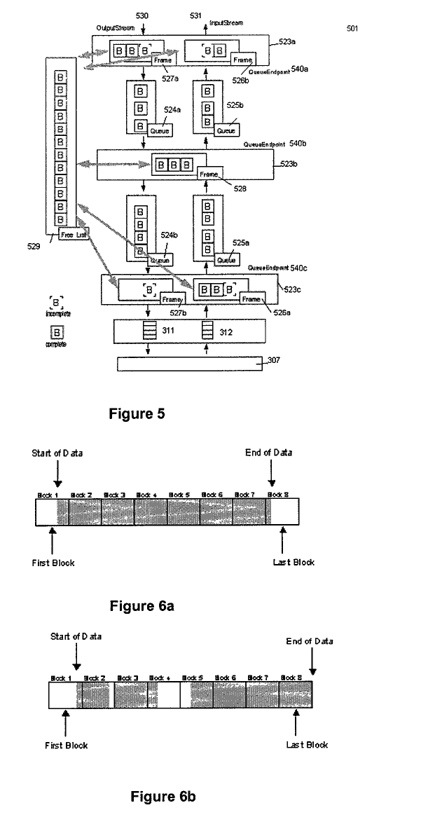

Referring now to FIG. 5, and any other Figures as needed, there is seen a representation of an embodiment of a Data Path Engine (DPE) 501. As described herein, the DPE 501 passes information between one or more of layers 523a-c of a protocol stack 422. The DPE 501 provides its functionality in a protocol independent manner because it is possible to decouple the management of memory blocks used for datagrams from the handling of those datagrams. Hence, the function of interpreting protocol specific datagrams is delegated to the layers.

The present invention identifies that enqueing and dequeing information from an information stream for use by different software layer threads of a protocol stack preferably should occur in a bounded and synchronized manner. To provide predictability to potentially unbounded operations that may result from an all Java or Java-like solution, the present invention disables interrupts when enqueing or dequeing information to or from software layers via queues.

The DPE 501 comprises certain data structures that are discussed herein first generally, then below, more specifically. The DPE 501 instantiates the whole DPE instance (for example, QueueEndpoints, Queues, Blocks, FreeList, that will be described below in further detail) at startup. In one embodiment, the DPE 501 comprises one or more receive and transmit queues 524a-b, 525a-b as may be specified at startup by the protocol stack 422. The queues may be used to transfer information contained in output 530 and input 531 information streams between layers 523a-c. Although only one queue in a receive and transmit direction is shown between any two layers in FIG. 5, it is understood from the descriptions herein that more than one queue between any two layers is within the scope of the present invention, for example, with different receive or transmit queues corresponding to different communications channels, or different queues corresponding to different information streams, for example, video and audio, or the like. Each layer 523a-c may comprise at least one thread that takes information from one or more queues 524a-b, 525a-b, that processes the information, and that makes the processed information available to another layer through another queue. In one embodiment, threads may comprise real-time threads. More than one protocol layer or queue may be serviced by the same thread. Flow control between layers may be implemented by blocking or unblocking threads based on flow control indications on the queues 524a-b, 525a-b. Flow control is an event which may occur when a queue becomes close to full and which may be cleared when it falls to a lower level.

The DPE 501 manages information embodied as blocks B of memory and links the blocks B together to form frames 526a-b, 527a-b, 528 as shown in FIG. 5. Frames may also be held by queues. As shown, a frame may comprise groups of one block, two blocks, four blocks, but may also comprise other numbers of blocks B. The threads comprising a layer may put frames to and take frames from the queues 524a-b, 525a-b. The DPE 501 allows that frames 526a-b, 527a-b, 528 may be passed between software layers, wherein adding, removing, and modifying information in the queues, frames, and blocks B occurs without corruption of the information. Blocks B may be recycled as frames are produced and consumed by the layers.

In one embodiment, queueendpoints 540a-c may comprise the layers 523a-c and may perform inspect-modify-forward operations on frames 526a-b, 527a-b, 528. For example, queueendpoints may take frames 526a-b, 527a-b, 528 from a queue or queues 524a-b, 525a-b to look at what is inside a frame to make a decision, to modify a frame, to forward a frame to another queue, and/or to consume a frame. In one embodiment, the DPE 501 has one thread per layer 523a-c and, thus, one thread per queueendpoint 540a-c. A thread may inspect the queues and may go waiting. A queueendpoint 540a-c may wait on an object. A queueendpoint may optionally wait on itself. Prior to waiting on itself, a queueendpoint 540a-c may register itself to all queues 524a-b, 525a-b that the queueendpoint terminates. When something is put into a queue 524a-b, 525a-b, or a congestion from the queue that was sourced by a queueendpoint 540a-c is cleared, the queue may notify the queueendpoint to wake the queueendpoint up, then the queueendpoint may take remedial action if there is congestion, or it can service the queue that it now has to service. In one embodiment, a software data structure may be shared between a queue 524a-b, 525a-b and a queueendpoint 540a-c that indicates a status as to whether or not a particular queue needs to be serviced by an queueendpoint. The structure may be local to the queueendpoint and may be exposed from the queueendpoint to the queues. The software structure may contain a flag to indicate, for example, if a queue is congested, if a queue is not congested, if a queue is empty, or if a queue is full.

With Java or Java-like languages, objects may be synchronized by using synchronized methods. Although Java or Java-like languages provide monitors that block threads to prevent more than one thread from entering an object and, thus, potentially corrupting data, the DPE 501 provides interrupt disabling and enabling mechanism by which a thread may be granted exclusive access to an object. The DPE 501 ensures that information may be transferred between layers in a deterministic manner without needing to trap on instructions (i.e., by not using monitors). In one embodiment, all interrupts are disabled.

The DPE 501 relies on a set of classes that enable the mechanism to pass bocks B of data across the thread boundary of a layer. The present invention does so because putting or taking a frame 526a-b, 527a-b, 528 from a queue 524a-b, 525a-b may occur quickly. In comparison, if synchronized methods were to be used to manage contention among queues attempting to enter a monitor of a layer, the contentions that could occur could consume a relatively large amount of time and latency would not be guaranteed (i.e., entering an monitor means locking an object).

In the DPE 501, before a frame is put into a queue 524a-b, 525a-b, interrupts are disabled, and once a frame has been put into a queue, interrupts are restored. Before interrupts are disabled, however, a queue notifies a respective queueendpoint that something is happening. Upon notification by a queue, a queuendpoint may enable and disable interrupts by calling a method called kernel.disable.interrupts-kernel.enable.interrupts. At load time a class loader may detect calls to kernel.disable.interrupts-kernel.enable.interrupts methods. When found, invoke instructions that call those methods are replaced by the loader with a disableInterrupt and enableInterrupt opcode (and 2 nop opcodes) to fully replace a 3 byte invoke instruction. By doing so, an invoke sequence that typically would take 30 to 100 clock cycles may be replaced by a process that is performed in about 4 clock cycles. By disabling interrupts with kernel.disable.interrupts, latency is guaranteed, whereas, when entering a monitor, latency cannot be guaranteed. As compared to using monitors, kernel.disable.interruptskernel.enable.interrupts may be 10 to 50 times faster in guaranteeing exclusive access to an object.

Because some protocols using the DPE 501 may sometimes operate under realtime constraints, they cannot allow well known standard garbage collection techniques to interfere with their execution. Garbage collection allocates and frees memory continuously, thereby being unbounded. To ensure that operations occur in a predefined time window, the DPE 501 pre-allocates blocks B at startup and keeps track of them in a free list 529. Memory may be divided and allocated into fixed size blocks B at start-up. In one embodiment, the memory is divided into small blocks B to avoid memory fragmentation. After creation, frames 526a-b, 527a-b, 528 may be consumed by the protocol stack 422, after which blocks B of memory may be recycled. The size of the queues 524a-b, 525a-b may be determined at startup by the protocol stack 422 so that any one layer 523a-c does not consume too many of the blocks B in the free list 529 and so that there are enough free blocks B for other layers, frames, or queues. Because all blocks B are statically pre-allocated in the freelist 529, with the present invention garbage collection need not be relied upon to manage blocks of memory. After startup, because the DPE 501 includes a closed reference to all its objects and doesn't have to allocate objects, for example blocks B, and because the DPE's threads operate at a higher priority than the garbage collector thread, it may operate independently and asynchronously of garbage collection.

The DPE 501 buffers information transferred between a source and destination and allows information to be passed by one or more queues 524a-b, 525a-b without having to copy the information, thereby freeing up bottlenecks to the processing of the information. Each layer 523a-c may process the information as needed without having to copy or recopy the information. Once information is allocated to a block B, it may remain in the memory location defining the block. Each layer 523a-c may add or remove headers and trailers from frames 526a-b, 527a-b, 528, as well as remove, add, modify blocks B in a frame through methods which are part of the Frame class instantiated in the layers 523a-c. Once information in an output 530 or input 531 stream is copied to a block B, it may be processed from that block B throughout the layers 523a-c of protocol stack 422, then streamed out of the block B to an application or other software or device. For example, in an input stream direction, information from a baseband circuit 307 needs be copied to a memory location only once before use by an application, the protocol stack 422, or other software.

Because in the DPE 501 different layers and their threads may read and write the same queue and, thus, the same frame and block, methods and blocks of code which access the memory location defining the queue, frame, or block would normally need remain synchronized to guarantee coherency of the DPE 501 when making read-modify-write operations to the memory location. As discussed earlier, synchronization is the process in Java that allows only one thread at a time to run a method or a block of code on a given instance. By providing an alternative to Java or Java-like synchronization, i.e., by disabling interrupts, the DPE 501 provides that if different threads do read-modify write operations on the same memory location, the information in the memory location, for example, global variables, does not get corrupted.

As referenced below, it will be understood that the conceptual entities described above may be implemented as software data structures. Hereafter, conceptual entities (for example, queue) are distinguished from software data structures (for example, Queue) by the capitalization of the first letter of their respective descriptor. Although such distinctions are provided below, it is understood that those skilled in the art may, as needed, when viewing the Figures and description herein, interpret the software data structures and corresponding physical or conceptual entities interchangeably.

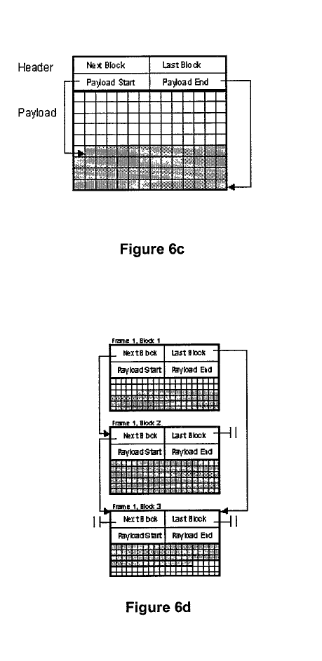

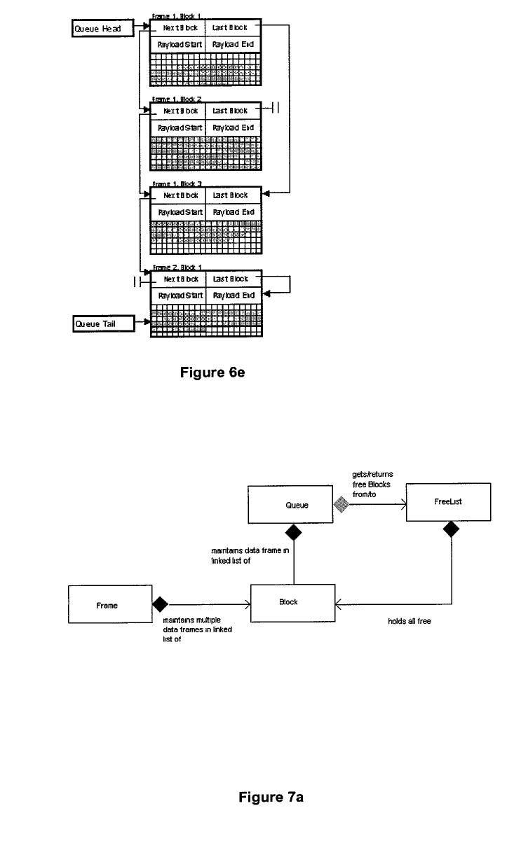

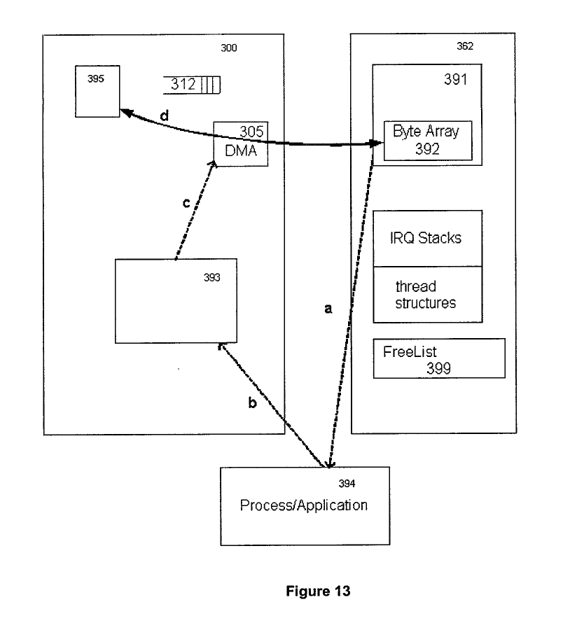

Referring now to FIGS. 6a-e, there are seen representations of Block, Frame, and Queue data structures. Referring now to FIGS. 6a, a frame may comprise a plurality of blocks B, each block comprising a fixed block size. A block B may comprise a completely full block of information or a partially full block of information. As described in FIG. 13 below, a byte array comprising a contiguous portion of memory may be an element of Block. A partially filled block B may be referenced by a start and end offset. As illustrated in FIG. 6b, after processing and reassembly of blocks B of a frame by a layer, a frame may no longer comprise contiguous information.

A frame may comprise multiple blocks B linked together by a linked list. The first block B in a block chain may reference the frame. Leading and trailing empty blocks B may be removed from a frame as needed. The number of blocks B in a frame may therefore change as processed by different layers. Adding or removing information to or from a block B may be implemented through Block class methods and Block class method data structures. In one embodiment, Block class may comprise the following variables:

Private. Start offset of a payload in a block B. The payload can start anywhere in a block provided it is not after the end of the payload. This allows unused space at the start of the block in a frame.

Private. End offset of payload in a block B. The payload can end anywhere in a block provided it is not before the start of the payload. This allows unused space at the end of the block in a frame.

Private. Payload in a block B. The payload of a contiguous array of bytes in a block.

Private. Next block B within in a frame. Null if the block is the last block in the frame. This reference may also be used to link blocks B in the free list of blocks.

Private. Last block B in a frame if the first block of a frame, null otherwise. This variable may serve two purposes. First it allows efficient access to the tail of the frame. Second, it allows delimiting frames if multiple frames are chained together.

As illustrated in FIG. 6c, information in a block B is at the end of the block. The information could also be at the start of the block. The first time information is written to a block B determines to which end of the block it will be put. A put to tail puts information at the start, and a put to head puts information at the end. As represented by the 3 blocks B comprising the frame in FIG. 6d, information may be added before or after a block B.

Referring now to FIG. 6e, and any other Figures as needed, a representation of a Queue class data structure is shown. Queue data structures may be used to manage frames. When a layer has finished processing a frame, an executing thread may put the frame onto a queue to make the frame available for processing by another layer, application, or hardware. The DPE 501 kernal.disableinterrupts-kernal.enableinterrupts classes, which disable and enable interrupts when information is queued onto or from a queue, in effect provide that synchronization occurs on the threads. A protocol stack may define more than one queue for each layer. The blocks B of a frame may be linked together using the next block reference within Block class and the last block references may be used to delimit the frames.

In one embodiment, member variables of the Queue Class may include:

Private. Maximum size of the queue in blocks.

Private. Flow control low threshold in blocks.

Private. Flow control high threshold in blocks.

Private. Flow control flag.

Private. First block in the queue.

Private. Last block in the queue.

Private. Consumer QueueEndpoint.

Private. Producer QueueEndpoint.

Putting to and getting from queues can be a blocking or non-blocking event for threads as specified in a parameter in enqueue() and dequeue() methods of the Queue class that take frames on and off a queue. If non-blocking has been specified and a queue is empty before a get, then a null block reference may be returned. If non-blocking has been specified and a queue is full before a put, then a status of false may be returned. If the access to the queue is blocking, then the wait will always have a loop around it and a notify all instruction may be used. Waits and notifies can be for queue empty/full or for flow control. A thread may be unblocked if its condition is satisfied, for example, queue_not_empty if waiting on an empty queue and queue_not_full if waiting to put to a full queue.

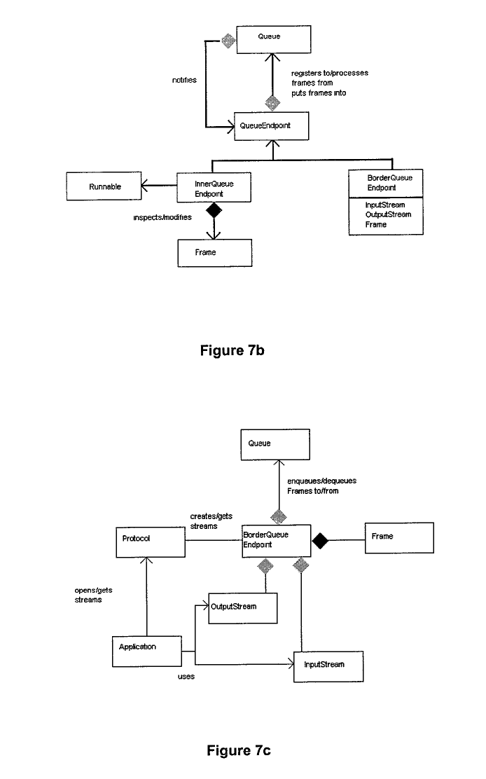

Referring now to FIGS. 7a-b, there are seen block diagram representations of subsystems of the DPE implemented as a memory management subsystem, and a frame processing subsystem, respectively. With reference to the software data structures and description above, the subsystems may be implemented with the software data structures disclosed herein, including, but not limited to, Block, Frame, Queue, FreeList, QueueEndpoint. FIG. 7a shows a representation of a memory management subsystem responsible for the exchange of Block handles/pointers between Queue, FreeList, and Frame. FIG. 7b shows a representation of a processing subsystem responsible for the functions of inspecting a frame, modifying a frame, and forwarding a frame with Frame.

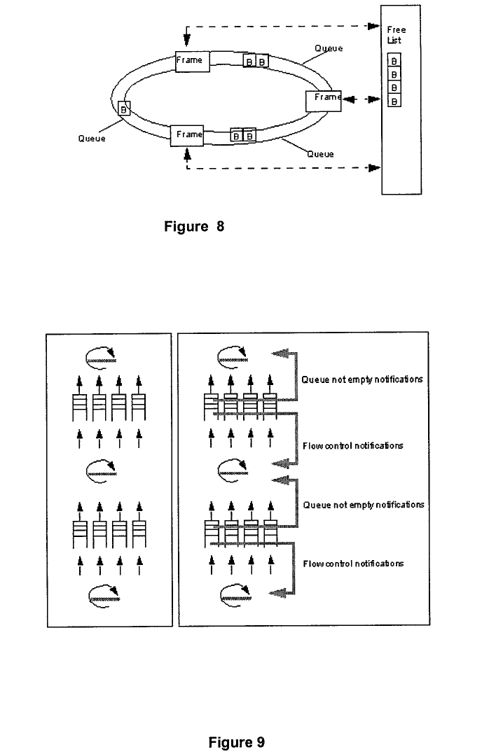

Referring now to FIGS. 7a and 8, and any other Figures as needed, there are seen representations of how memory management may effectuated by using a FreeList data structure that operates independent of a garbage collection mechanism, whereby Block handles/pointers are exchanged in a closed loop between FreeList, Frames, and Queue data structures, and such that the DPE 501 may operate under real-time constraints without losing reference to the blocks B.

The Block data structure is used to transfer basic units of information (i.e., blocks B). At any point in time, a block B uniquely belongs either to FreeList if it is free, Frame if it is currently held by a protocol layer, or Queue if it is currently across a thread boundary. More than one block B may be chained together into a block chain to form a frame. An instance of the Frame class data structure is a container class for Block or a chain of Blocks. More than one frame may also be chained together. The Block data structure may comprise two fields to point to the next block B and the last block B in a block chain. The next block B after the last block of a block chain indicates the start of the next block chain. A block chain may comprise a payload of information embodied as information to be transported and a header that identifies what the information is or what to do with it.

Referring now to FIGS. 7b, and any other Figures as needed, Queue may be modified with QueueEndpoint. Blocks B in a block chain may be freed or allocated to or from FreeList with QueueEndpoint. All blocks B to be used are allocated at system startup inside FreeList, allowing the memory for chaining blocks B to be available in real time and not subject to garbage collection.

The Queue data structure may be used to transfer a block chain from one thread to another in a FIFO manner. Queue exchanges Blocks with Frame by moving a reference to the first block of a chain of Blocks from Frame to Queue or vice versa. Queue is tied to two instances of QueueEndpoints.

The Frame data structure comprises a basic container class that allows protocols to inspect, modify, and forward block chains. Frame may be thought of as an add/drop MUX for blocks B. All block chain manipulations may be done through the Frame data structure in order to guarantee integrity of the blocks B. The Frame data structure abstracts Block operations from the protocol stack. To process information provided by more than one frame simultaneously, Frame instances are private members of QueueEndpoint instances. Unlike instances of Queue, which may contain multiple chains of Blocks, instances of Frame may contain one chain of Blocks. All frames and queues may be allocated at startup, just like blocks; however, unlike blocks B that are allocated as actual memory, Frame and Queue may be instantiated with a null handle that can be used later to point to a chain of blocks.

FreeList comprises a container class for free blocks B. FreeList comprises a chain of all free blocks B. There is typically only one FreeList per protocol stack 422. Operations on instances of Frame that allocate or release blocks B interact with the FreeList. All blocks B within the freelist preferably have the same size. The FreeList may cover all layers of a protocol stack, from a physical hardware layer to an application layer. FreeList may be used when allocating, freeing, or adding information to/from a frame. In one embodiment, synchronization may be provided on the instance of FreeList. Every time a block B crosses a thread boundary, interrupts are disabled and then enabled, for example, every time a block B goes into the freelist or a queue, or a queuendpoint, layer, or thread boundary is crossed.

Referring to FIG. 8, and any other Figures as needed, there is seen a representation of an illustration of multiple queues interacting with queueendpoint threads. As described herein, because a thread can be used to service multiple queues, on both transmit and receive, and because the Java threading model allows threads to wait on one and only one monitor, a queueendpoint preferably waits on one object (optionally itself) and all queues notify that object (optimally the queueendpoint).

Referring now to FIGS. 7b and 9, and any other Figures as needed, there is seen a frame processing subsystem responsible for dequeing a frame, inspecting its header, and consuming or forwarding the contents of a frame. A frame may be modified before being forwarded. InnerQueueEndpoint holds handles to instances of Queue, which may contain instances of Frame. InnerQueueEndpoint comprises its own thread to process Frame instances originating from Queue instances. Once it has completed its tasks, an InnerQueueEndpoint thread may wait for something to do. Notifications come from instances of Queue, which notify a destination QueueEndpoint that it just changed from empty to not empty, or a source QueueEndpoint that it crossed a low threshold or it that it changed from congested to not congested.

A queue may be bounded by two queueendpoints, and may be serviced by different threads of execution. Instances of Queue may provide an interface for notification that can be used by QueueEndpoint. Instances of Queue may also hold a reference to both queueendpoints, which the DPE 501 can use for notifications when queue events occur. Queue may specify control thresholds (hi-low) as well as a maximum number of blocks B to help to debug for conditions that could deplete the freelist. Flow control ensures that the other end of a communication path is notified if an end can't keep up, i.e., if a queue is filling up it can be emptied. InnerQueueEndpoint is responsible for creating, processing, or terminating block chains.

QueueEndpoint class may contain two fields “queueCongested” and “queueNotEmpty”. QueueEndpoint may comprise an array with which it can readily access queuecongested and queueNotEmpty, where the status elements of the array are shared with respective queues. A queue may set one of these fields, which may be used to notify a queueendpoint that it has a reason to inspect the queue. QueueEndpoint allows optimizations of queue operations, for example, queueendpoints are able to determine which queue needs to be serviced from notifications provided by a queue. The DPE 501 provides a means by which every queue need not be polled to see if there is something to do based on a queue event. Previously, with standard Java techniques, to see if a queue would be empty or full, a query would have been made through a series of synchronized method calls, which would implicate the previously discussed contention and latency issues. By making decisions through an internal data structure, method calls may be replaced by direct field access of data structures.

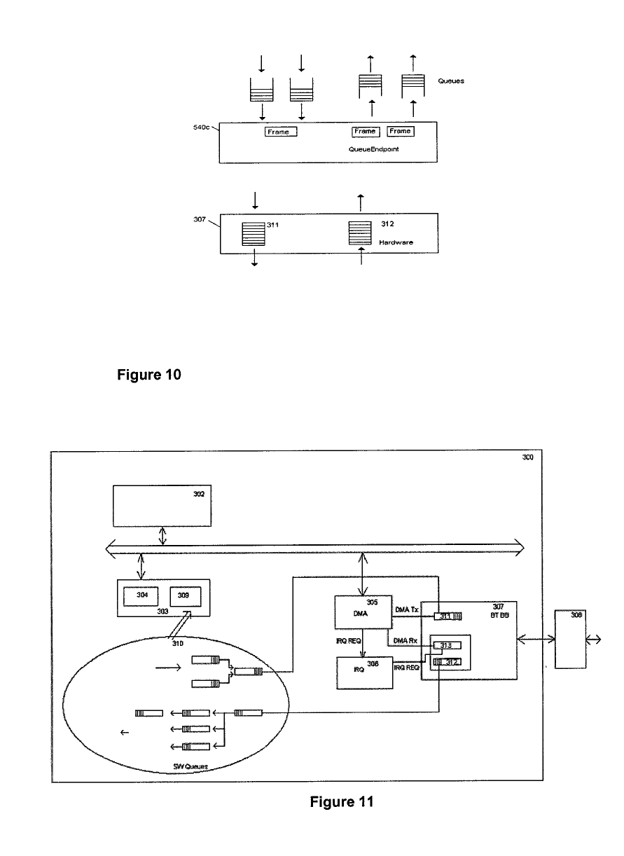

Referring now to FIG. 10, and any other Figures as needed, there is seen a representation of a hardware interface to the DPE. At the hardware level, transfers of information to/from a receive or transmit FIFO buffer of a baseband circuit 307 or other hardware used to transfer information may occur through Interrupt Service Routines (ISRs) and Direct Memory Access (DMA) requests that interface to the DPE 501 through the Block data structure. At the lowest hardware level, a framer may operate on the information from the FIFO. The framer may comprise hardware or software. In one embodiment, a software framer comprises interrupt service threads that are activated by hardware interrupts when information is received by the FIFO from input 531 or output 530 streams. The Frame data structure is filled or emptied with information from an output 530 or input 531 stream at the hardware level by the framer in block B sized increments. The queueendpoint closest to the hardware services hardware interrupts and DMA requests from peripherals by a QueueEndpoint interface to the transmit and receive buffers 312, 311 which may be accessed by the software support layer's kernel. QueueEndpoint registers to a particular hardware interrupt by making itself known to the kernel. QueueEndpoint is notified by the interrupts it is registered to. The kernel has a reference to a QueueEndpoint in its interrupt table, which is used to notify a thread whenever a corresponding interrupt occurs.

Referring now to FIG. 11 and other Figures as needed there is seen an embodiment as described herein. Circuit 300 may utilize a software protocol stack 422 and DPE 501, as described previously herein, when communicating with peripherals or devices. In one embodiment, the communications may occur over a baseband circuit 307 that is compliant with a Bluetooth™ communications protocol. Bluetooth™ is available form the Bluetooth Special Interest Group (SIG) founded by Ericsson, IBM, Intel, Lucent, Microsoft, Motorola, Nokia, and Toshiba, and is available as of this writing at www.bluetooth.com/developer/specification/specification.asp. It is understood that although the specifications for the Bluetooth communications protocol may change from time to time, such changes would still be within the scope and spirit of the present invention. Furthermore, other wireless communications protocols are within the scope and skill of the present invention as well as those skilled in the art, including, 802.11, HomeRF, IrDA, CDMA, GSM, HDR, and so called 3^{rd} Generation wireless protocols such as those defined in the Third Generation Partnership Project (3GPP). Although described above in a wireless context, communications with circuit 300 may also occur using wired communication protocols such as TCP/IP, which are also within the scope of the present invention. In other embodiments, wireless or wired data transfer may be facilitated as ISDN, Ethernet, and Cable Modem data transfers. In one embodiment, a radio module 308 may be used to provide RF wireless capability to baseband circuit 307. In one embodiment, radio module 308 may be included as part of the baseband circuit 307, or may be external to it. Bluetooth technology is intended to have low power consumption and utilize a small memory footprint, and is, thus, well suited for small resource constrained wireless devices. In one embodiment, circuit 300 may include baseband circuit 307 and processor core 302 functionality on one chip die to conserve power and reduce manufacturing costs. In one embodiment, the circuit 300 may include the baseband circuit 307, processor core 302, and radio module 308 on one chip die.

In the prior art, access to peripheral's/device's functionality may be accomplished through lower level languages. For example, in previously existing hardware accelerators that implement Java, Java “native methods” (JNI) require an interface written in, for example, a C programming language, before the native methods can access a peripheral functionalities. In contrast to the prior art, the embodiments described herein provide applications or other software residing on or off circuit 300 direct access to the functionality and features of peripherals or devices, for example, access to the data reception/transmission functionality of baseband circuit 307.

In one embodiment, memory 362 of circuit 300 may be embodied as any of a number of memory types, for example: a SRAM memory 309 and/or a Flash memory 304.

In one embodiment, the memory 362 may be defined by an address space, the address space comprising a plurality of locations. In one embodiment, the software data structures described previously herein (indicated generally by descriptor 310) may be mapped to the plurality of locations. In one embodiment, the software data structures 310 may span a contiguous address space of the memory 362. Data received by baseband circuit 307 may be tied to the data structures 310 and may be accessed or used by an application program or other software. In one embodiment data may be accessed at an application layer program level through API 419 As described herein, in one embodiment the software data structures 310 may comprise objects. In one embodiment, the objects may comprise Java objects or Java-like objects. In one embodiment, the data structures 310 may comprise one or more Queues, Frames, Blocks, ByteArrays and other software data structures as described herein.

In one embodiment, circuit 300 may comprise a receive 312 (Rx) and transmit 311 (Tx) buffer. In one embodiment, the receive 312 (Rx) and transmit 311 (Tx) buffers may be embodied as part of the baseband circuit 307. As described further herein, information residing in the baseband receive 312 (Rx) and transmit 311 (Tx) buffers may be tied to the data structures 310 with minimal software intervention and minimal physical copying of data, thereby eliminating the need for time consuming translations of the data between the baseband circuit 307 and applications or other software. In one embodiment, an application or other software may utilize the received information directly as stored in the locations in memory 362. In one embodiment, the stored information may comprise byte-codes. In one embodiment, the byte-codes may comprise Java or Java-like byte-codes. In other embodiments, it is understood that information as described herein is not limited to byte-codes, but may also include other data, for example, bytes, words, multi-bytes, and information streams to be processed and displayed to a user, for example, an information stream such as an audio data stream, or database access results. In one embodiment, the information may comprise a binary executable file (binary representations of application programs) that may be executed by processor core 302. Unlike prior art solutions, the embodiments described herein enable transparent, direct, and dynamic transfer of data, reducing the number of times the information needs to be copied/recopied before utilization or execution by applications, the protocol stack, other software, and/or the processor core 302.

As previously described, the software data structures 310 in memory 362 may be constructs representing one or more blocks B in queues 524a-b, 525a-b that act as FIFOs for the information streams 530, 531. Data or information received by radio module 308 may be communicated to the baseband circuit 307 from where it may be transferred from the receive 312 buffer to a queue 524a-b, 525a-b by the DMA controller 305; or may originate in a queue 524a-b, 525a-b from where it may be transferred by the DMA controller 305 to the transmit buffer 311 and from the transmit buffer to the radio module 308 for transmission. Setup of a transfer of data may rely on low level software interaction, with “low level software” referring to software instructions used to control the circuit 300, including, the processor core 302, the DMA controller 305, and the interrupt request IRQ controller 306. Preferably, no other software interaction need occur during a DMA transfer of data between baseband circuit 307 and memory 362. From the point of view of the DMA controller 305, data in a block B of a queue 524a-b, 525a-b is in memory 362, and the baseband circuit 307 is a peripheral. DMA transfers may occur without software intervention after the low level software specifies a start address, a number of bytes to transfer, a peripheral, and a direction. Thereafter, the DMA controller 305 may fill up or empty a receive or transmit buffer when needed until a number of units of data to transfer has been reached. Events requiring the attention of low level software control may be identified by an IRQ request generated by IRQ controller 306. Type of events that may generate an IRQ request include: the reception of a control packet, the reception of the first fragment of a new packet of data, and the completion of a DMA transfer (number of bytes to transfer has been reached).

In a receive mode, the baseband receive buffer 312 may hold data received by the radio module 308 until needed. In one embodiment, circuit 300 may comprise a framer 313. In one embodiment, the framer 313 may be embodied as hardware of the baseband circuit 307 and/or may comprise part of the low level software. The framer 313 may be used to detect the occurrence of events, which may include, the reception of a control packet or a first fragment of a new packet of data in the receive buffer 312. Upon detection, the framer 313 may generate an IRQ request. In one embodiment, when receiving, an application or other software in memory 362 may use high level software protocols to listen to a peer application, for example, a web server application on an external device acting as an access point for communicating over a Bluetooth link to the baseband circuit 307. Low level software routines may be used to set up a data transfer path between the baseband circuit 307 and the peer application. Data received from a peer application may comprise packets which may be received in fragments. The framer 313 may inspect the header of a fragment to determine how to handle it. In the case of a control packet, low level software may perform control functions such as establishing or tearing down connections indicated by the start or end of a data packet. If a fragment is marked as a first fragment of a packet, the framer 313 may generate an interrupt allowing the low level software to allocate the fragment in an input stream to a block B. The framer may then issue DMA 305 requests to transfer all the fragments of the packet from the baseband receive buffer 312 to the same block B. If a block in the queue 525a-b fills up, the DMA 305 may generate an interrupt and the low level software may allocate another block B to a queue. Upon reception of another fragment, marked as a first fragment of another packet, the framer 312 may generate another interrupt to transfer the data to another block B in the same queue.

In a transmit mode, the baseband circuit 307 transmit buffer 311 may receive data from an application or other software executing under control of the processor core 302, and when received, may send the data to the radio module 308 in its entirety or in chunks at every transmit opportunity. In a time division multiplexed system, a transmit time slot may be viewed as a transmit opportunity. When a queue 524a-b, in an output stream receives a block B of data from an application or other software, the low level software may configure the DMA 305 and tie that queue to the baseband transmit buffer 311. The baseband transmit buffer 311, if empty, may issue a request to get filled up by the DMA 305. Every time the baseband transmit buffer 311 is not full or reaches a predetermined watermark, it may issue another DMA request until the first block B that was allocated in the queue in the transmit chain has been completely transferred to the buffer, at which point the DMA 305 may request an interrupt. The low level software may service the interrupt by providing the DMA 305 with another block B as filled with data from an application or other software. In one embodiment, the processor core 302 may be switched into a power saving mode between reception or transmission of two data packets. In one embodiment, when transmitting, a web application program may communicate using high level software protocols via baseband circuit 307 with other applications, software, or peripherals or devices, for example, a web server application located on an external device. Layered on top of this communication may be a high level HTTP protocol. In one embodiment, the external device may be a mobile wireless device or an access point providing a wireless link to web servers, the Internet, other data networks, service provider, or another wireless device.

In one embodiment, the memory 362 may comprise a Flash memory 304, which could be used to store application programs, VM executive, or APIs. The contents of the Flash memory 304 may be executed directly or loaded by a boot loader into RAM 309 at boot-up. In one embodiment, after startup, an updated application, VM, and/or API provided by an external radio module 308 could be uploaded to RAM 309. After a step of verifying the operability of the uploaded software, the updated software could be stored to the Flash memory 304 for subsequent use (from RAM or Flash memory) upon subsequent boot-up. In one embodiment, updated applications, software, APIs, or enhancements to the VM may be stored in Flash memory or RAM for immediate use or later use without a boot-up step.

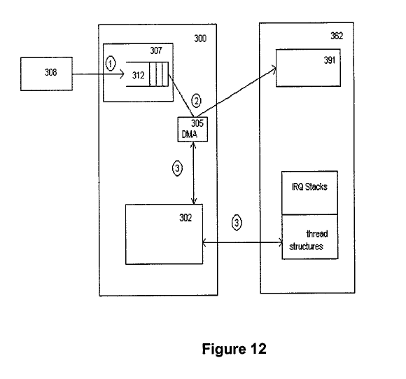

Referring to FIG. 12 and other Figures as needed, there is seen represented an information transfer into a software data structure. In one embodiment, circuit 300 and a DMA 305 are configured to allow the transfer of data from a peripheral or device directly into a software data structure. Once data is transferred into the data structure 310, it may be utilized by an application program, other software, or hardware without any further movement of the data from its location in memory 362. For example, if the data comprises Java or Java-like byte-codes, the byte-codes may be executed directly from the their location in memory. By reducing or eliminating the transfers of data before use of the data, fewer processor instructions may be executed, less power may be consumed, and circuit 300 operation may be optimized. In one embodiment, a data transfer may occur in the following steps:

1. A packet of data from a peripheral or device may be received and stored in a receive buffer 312 of a device or peripheral. The peripheral or device may comprise an on or off circuit 300 peripheral (on circuit shown). In one embodiment, the peripheral or device may comprise baseband circuit 307.

2. Reception of data in the receive buffer 312 may generate a DMA 305 request. The DMA request may flush the receive buffer 312 directly into a data structure 391.

3. After the DMA 305 transfer of the data, the processor core 302 may be notified to hand the data off to an application or other software.

Although a DMA 305 is described herein in one embodiment as being used to control the direct transfer and execution of data from a peripheral or device with a minimal number of intervening processor core 302 instruction steps, it is understood that the DMA 305 comprises one possible means for transferring of data to the memory, and that other possible physical methods of data transfer between a peripheral or device and the memory 362 could be implemented by those skilled in the art in accordance with the description provided herein. One such embodiment could make use of an instruction execution means, for example, the processor core 302, to execute instructions to perform a read of data provided by a peripheral or device and to store the data temporarily prior to writing the data to the memory 362, for example, in a programmable register in the processor core 302. In one embodiment, the programmable register could also be used to write data directly to a data structure 310 in memory 362 to effectuate operations using the data in as few processor instruction steps as possible. In contrast to the DMA embodiment described previously, in which large blocks of data may be transferred to memory 362 with one DMA instruction, in the this embodiment, the processor core 302 may need to execute two instructions per unit of data stored in the peripheral or device receive buffer 312, for example, per word. The two instructions may include an instruction to read the unit of data from the peripheral or device and an instruction to write the unit of data from the temporary position to memory 302. Although, compared to the DMA embodiment described above, two processor instructions per unit of data could consume more power and would use processor cycles that could be used for other processes, execution of two instructions, as described herein, is still fewer than the number of instructions that need to be executed by the prior art. For example, the methodology of FIG. 2 requires the transfer of a unit of data from a peripheral or device to memory, including at least the following steps: a transfer of the data from the FIFO 198 to a register in the processor core 196, a transfer of the data from the core to the receive buffer 192, a transfer of the data from the buffer to the processor core 196, and finally, a transfer of the data from the core into a Java object 191, which would necessitate the execution of at least four processor instructions (read-writeread-write) per unit of data.

Referring to FIG. 13 and other Figures as needed, there is seen an embodiment as described herein. A software data structure 391 may comprise a Block data structure, as described herein previously. In one embodiment, the Block data structure may comprise a Java or Java-like software data structure, for example, a Block object. In one embodiment, the Block object may comprise a ByteArray object. After instantiation, the Block object's handle/pointer may be referenced and saved to a FreeList data structure. The handle may be used to access the ByteArray object. With the ByteArray object pushed to the top of the stack (TOS), the base address of the ByteArray object may be referenced by a pointer.

In one embodiment, the (TOS) value may be stored in a memory mapped DMA buffer base address register. To do so, circuit 300 may include registers that may be read and written using an extended byte-code instruction not normally supported by standard Java or Java-like virtual machine instruction sets, for example, with an instruction providing functionality similar to a PicoJava register store instruction. A ByteArray object of a Block object may be defined as comprising a predefined size, for example Byte[ ] a=new Byte [20] may set aside 20 contiguous byte-size memory locations for the ByteArray object. The predefined size may be written to a DMA “word count register” to specify how many transfers to conduct every time the DMA is triggered to service a peripheral or device, for example, the baseband circuit 307. With one DMA channel dedicated to each peripheral or device, the word count register would need to be initialized only once, whereas the DMA buffer base address register would need to be modified for every new Block object, for example: void Native setUpDMA( nameOfByteArray, sizeOfByteArray) {write nameOfByteArray to the DMA memory buffer register write sizeOfByteArray to the DMA word count register return }whereby a caller could call setUpDMA as follows: setUpDMA( aByteArray, sizeOF(aByteArray)) In one embodiment, a ByteArray data structure may be set up to receive data from a peripheral or device in the following steps:

a—An application or other software 394 may obtain a handle of, or reference to, a Byte Array data structure which could, for example, be stored as a field in a data structure, for example a Block data structure, or which could be present in a current execution context as a local variable.

b—The handle may be pushed onto a stack 393, for example, on a stack cache or onto a stack in memory, thereby becoming the top of stack (TOS) element.

c—The TOS element may be written to an appropriate DMA 305 buffer base address register.

d—A peripheral or device 395 may initiate a DMA transfer, writing information to or from the peripheral or device directly into the pre-instantiated ByteArray data structure as specified by the DMA buffer base address register.

In one embodiment, circuit 300 may operate as or with a wireless device, a wired device, or a combination thereof. In one embodiment, the circuit 300 may be implemented to operate with or in a fixed device, for example a processor based device, computer, or the like, architectures of which are many, varied, and well known to those skilled in the art. In one embodiment, the circuit 300 may be implemented to work with or in a portable device, for example, a cellular phone or PDA, architectures of which are many, varied, and well known to those skilled in the art. In one embodiment, the circuit 300 may be included to function with and/or as part of an embedded device, architectures of which are many, varied, and well known to those skilled in the art.

While some embodiments described herein may be used with data comprising Java or Java-like data and byte-codes, and Java or Java-like objects or data structures including, but not limited, those used in J2SE, J2ME, PicoJava, PersonalJava and EmbeddedJava environments available from Sun Microsystems Inc, Palo Alto, it is understood that with appropriate modifications and alterations, the scope of the present invention encompasses embodiments that utilize other similar programming environments, codes, objects, and data structures, for example, C# programming language as part of the .NET and .NET compact framework, available from Microsoft Corporation Redmond, Washington; Binary Run-time Environment for Wireless (BREW) from Qualcomm Inc., San Diego; or the MicrochaiVM environment from Hewlett-Packard Corporation, Palo Alto, Calif. The Windows operating systems described herein are also not meant to be limiting, as other operating systems/environments may be contemplated for use with the present invention, for example, Unix, Macintosh OS, Linux, DOS, PalmOS, and Real Time Operating Systems (RTOS) available from manufacturers such as Acorn, Chorus, GeoWorks, Lucent Technologies, Microware, QNX, and WindRiver Systems, which may be utilized on a host and/or a target device. The operation of the processor and processor core described herein is also not meant to be limiting as other processor architectures may be contemplated for use with the present invention, for example, a RISC architecture, including, those available from ARM Limited or MIPS Technologies, Inc. which may or may not include associated Java or other semi-compiled/interpreted language acceleration mechanisms. Other wireless communications protocols and circuits, for example, HDR, DECT, iDEN, iMode, GSM, GPRS, EDGE, UMTS, CDMA, TDMA, WCDMA, CDMAone, CDMA2000, IS-95B, UWC-136, IMT-2000, IEEE 802.11, IEEE 802.15, WiFi, IrDA, HomeRF, 3GPP, and 3GPP2, and other wired communications protocols, for example, Ethernet, HomePNA, serial, USB, parallel, Firewire, and SCSI, all well known by those skilled in the art may also be within the scope of the present invention. The present invention should, thus, not be limited by the description contained herein, but by the claims that follow.

What is claimed is:

1. An apparatus for utilizing information, comprising:
a memory, the memory comprising at least one data structure; and
a plurality of layers, each layer comprising at least one thread, each thread utilizing each data structure from the same portion of the memory.

2. The apparatus of claim 1, further comprising an application layer and a hardware layer, wherein the application layer comprises one of the plurality of layers, wherein the hardware layer comprises one of the plurality of layers, wherein the application layer and hardware layer utilize each data structure from the same portion of memory.

3. The apparatus of claim 2 wherein at least one of the plurality of layers comprises a realtime thread.

4. The apparatus of claim 1, wherein each data structure comprises a block object, wherein at least a portion of each block object is comprised of a contiguous portion of the memory.

5. The apparatus of claim 4, wherein the contiguous portion of the memory is defined a byte array.

6. The apparatus of claim 1, wherein the at least one data structure comprises a block object.

7. The apparatus of claim 1, further comprising a Java or Java-like virtual machine, wherein each thread comprises a Java or Java-like thread, wherein the Java or Java-like thread utilizes the same portion of memory independent of Java or Java-like monitors.

8. The apparatus of claim 1, the apparatus further comprising interrupt means for disabling interrupts; and a Java or Java-like virtual machine capable of executing each thread, wherein each thread utilizes the same portion of memory after the interrupts are disabled by the interrupt means.

9. The apparatus of claim 8,wherein all interrupts are disabled before each thread utilizes the same portion of memory.

10. The apparatus of claim 8, wherein the threads disable the interrupts via the interrupt means.

11. The apparatus of claim 1, wherein the information is received by the apparatus as streamed information, wherein each data structure is preallocated to the memory prior reception of the information.

12. The apparatus of claim 4, further comprising a freelist data structure, wherein each block object is preallocated to the freelist data structure by the apparatus prior to utilization of the information.

13. The apparatus of claim 12, the apparatus further comprising a protocol stack, the protocol stack residing in the memory, wherein the protocol stack preallocates each block to the freelist data structure.

14. The apparatus of claim 1, the apparatus further comprising a virtual machine, the virtual machine utilizing a garbage collection mechanism, the virtual machine running each thread, each thread utilizing the same portion of the memory independent of the garbage collection mechanism.

15. The apparatus of claim 14, wherein the garbage collection mechanism comprises a thread, wherein the threads comprise Java-like threads, wherein the threads each comprise a priority, wherein the priority of the Java-like threads is higher than the priority of the garbage collection thread.

16. The apparatus of claim 1, wherein each data structure comprises a block object, and further comprising a freelist data structure and at least one queue data structure, each block object comprising a respective handle, wherein at any given time the respective handle belongs to the freelist data structure or a queue data structure.

17. The apparatus of claim 6, further comprising, at least one queue data structure; and at least one frame data structure, each frame data structure comprising an instance of one or more block objects, each block object comprising a respective handle, each queue data structure capable of holding an instance of at least one frame data structure, and each thread using the queue data structure to pass a block handle to another thread.

18. The apparatus of claim 1, further comprising a virtual machine, the virtual machine running each thread; at least one queueendpoint, each queueendpoint comprising at least one of the threads; and at least one queue, each queue comprising ends, each end bounded by a queueendpoint, each queue for holding each of data structures in a data path for use by each queuendpoint, wherein each queue notifies a respective queueendpoint when the queue needs to be serviced by the queueendpoint, wherein a queueendpoint passes instances of each data structure from one queue to another queue by a respective handle belonging to the data structure.

19. The apparatus of claim 18, wherein a queue notifies a respective queueendpoint upon the occurrence of a queue empty event, queue not empty event, queue congested event, or queue not congested event.

20. The apparatus of claim 19, further comprising a queue status data structure shared by a queue and a respective queueendpoint, wherein the queue sets a flag in the data status structure to notify the respective queueendpoint when the queue needs to be serviced.

21. An apparatus for utilizing a stream of information in a data path, comprising:
a memory, the memory comprising at least one data structure, each data structure comprising a pointer;
a plurality of layers, the data path comprising the plurality of layers, the stream of information comprising the at least one data structure, each layer utilizing each data structure via its pointer.

22. The apparatus of claim 21, wherein each layer comprises at least one thread, each thread utilizing each data structure from the same portion of the memory.

23. The apparatus of claim 22, further comprising an interrupt disabling mechanism; and at least one queue, each queue disposed in the data path between a first layer and a second layer, the first layer comprising a producer thread, the second layer comprising a consumer thread, the producer thread for enqueuing each data structure onto a queue, the consumer thread for dequeing each data structure from the queue, wherein prior to dequeing and enqueing each data structure interrupts are disabled.

24. The apparatus of claim 22, the apparatus further comprising a virtual machine, the virtual machine comprising a garbage collection mechanism, the virtual machine running each thread independent of the garbage collection mechanism.

25. A system for utilizing data structure with a plurality of threads, comprising;
an interrupt mechanism for enabling and disabling interrupts;
a memory, the memory comprising at least one data structure; and
a plurality of threads, the plurality of threads utilizing the data structures after disabling interrupts with the interrupt mechanism.

26. The system of claim 25, wherein the plurality of threads utilize each of the data structures from the same portion of memory.

27. A system for accessing streaming information with a plurality of threads, comprising:
a memory; and
interrupt means for enabling and disabling interrupts; wherein the plurality of threads access the streaming information from the memory by disabling the interrupts via the interrupt means.

28. The system of claim 27, further comprising a memory, wherein the plurality of threads access the streaming information from the same portion of the memory.

29. A method for accessing information in a memory with a plurality of threads, comprising the steps of:
transferring information from one thread to another thread via handles to the information; and
disabling interrupts via the threads before performing the step of transferring the information.

30. The method of claim 29, further comprising a step of accessing the information with the plurality of threads from the same portion of the memory.
